(19) United States
(12) Patent Application Publication
(10) Pub. No.: US 2026/0094358 A1
(43) Pub. Date: Apr. 2, 2026

(54) HORIZONTAL IMAGE SHIFT FOR STEREO VIEWING COMFORT

(71) Applicant: Apple Inc., Cupertino, CA (US)

(72) Inventors: Vedant Saran, Campbell, CA (US); Alexander Menzies, Menlo Park, CA (US); Robert T. Held, Seattle, WA (US)

(21) Appl. No.: 19/322,870

(22) Filed: Sep. 9, 2025

Related U.S. Application Data
(60) Provisional application No. 63/700,072, filed on Sep. 27, 2024.

(51) Int. Cl. G06T 15/20; G06T 5/70; G06T 7/50; G06T 15/50

(52) U.S. Cl. CPC G06T 15/205; G06T 5/70; G06T 7/50; G06T 15/50

(57) ABSTRACT

Various implementations disclosed herein include devices, systems, and methods that uses a horizontal shift of left eye and right eye image content to control a stereo effect of the image content. For example, a process may include obtaining image data including images to be presented with a stereo effect at a virtual screen position within a three-dimensional (3D) viewing environment. The process may further obtain depth data corresponding to distances of elements of a scene depicted in the images. The process may further determine a horizontal positioning characteristic for presenting the images at the virtual screen with the stereo effect based on the depth data and a view of the images are presented with the stereo effect based on the horizontal positioning characteristic at the virtual screen within the 3D environment. The images may additionally be presented with a blur, a lighting, a fading, and/or a vignetting effect.

### CROSS REFERENCE TO RELATED APPLICATIONS

This Application claims the benefit of U.S. Provisional Application Serial No. 63/700,072 filed September 27, 2024, which is incorporated herein in its entirety.

### TECHNICAL FIELD

The present disclosure generally relates to systems, methods, and devices that use a disparity shift of left eye and right eye image content to control a stereo effect for viewing.

### BACKGROUND

Existing content presentation systems may be improved to provide accurate, desirable, and enhanced viewing experiences.

### SUMMARY

Various implementations disclosed herein include devices, systems, and methods that display a stereo view (e.g., left and right eye views) of image content at a virtual screen position within a three-dimensional (3D) environment. For example, the stereo view may be presented on a virtual screen at a specified position (e.g., a few feet) in front of a user in an extended reality (XR) environment presented via a head mounted device (HMD).

In some implementations, a horizontal shift or movement of left eye and/or right eye image content may be implemented to control or correct an amount or type of stereo effect being applied to image content to provide a comfortable or otherwise desirable viewing experience for a user. For example, a horizontal shift of left eye and/or right eye image content may be used to enable or influence an amount an object appears to pop or recess in a stereo view of the image content.

In some implementations, an amount of horizontal shift may be selected to provide a comfortable or otherwise desirable viewing experience. In some implementations, an amount of horizontal shift may be selected based on depths of objects depicted in the image content. For example, depths of objects within image content may be associated with a determined distance of the objects from an image capture device, e.g., the device that captured image data from which the content is produced. In this instance, the depths may be determined based on image analysis or information from an image-capture device (e.g., a camera) such as, inter alia, camera focus distance, interpupillary distance (IPD) parameters, etc.

In some implementations, an amount of horizontal shift to be applied to image content may depend upon a playback environment such as, inter alia, a size and/or a position of image content and/or a virtual screen relative to a viewer, a location associated with a user view, etc. In some implementations, an amount of horizontal shift may be determined such that image content located at minimum and maximum depths may be comfortably viewed. In some implementations, if a range of depths exceeds a threshold, a horizontal shift may be determined by prioritizing specified portions of an image scene. For example, a saliency map defining visual attributes associated with a view (of an image scene) of a user (e.g., visually interesting portions of an image scene) may be used to prioritize specific portions of the image scene.

In some implementations, a minimum and maximum depth for all frames of a video may be used to determine a horizontal shift used for all frames based on determining characteristics of the video as a whole, e.g., determining that the video does not include an excessive number of minimum and maximum depth changes.

In some implementations, image content may be presented with a blur effect, a lighting effect, a vignetting effect, and/or a fading effect to address issues such as, inter alia, user interface (UI) overlap, a window violation, left/right eye view inconsistencies, etc.

In some implementations, an HMD has a processor (e.g., one or more processors) that executes instructions stored in a non-transitory computer-readable medium to perform a method. The method performs one or more steps or processes. In some implementations, image data depicting a scene is obtained. The image data includes one or more images to be presented with a stereo effect at a virtual screen position within a 3D viewing environment. In some implementations, depth data corresponding to distances of one or more elements of the scene depicted in the one or more images is obtained. The distances are relative to a reference position. In some implementations, a horizontal positioning characteristic is determined for presenting the one or more images at the virtual screen with the stereo effect based on the depth data. In some implementations, a view of the one or more images is presented at the virtual screen within the 3D environment. The one or more images are presented with the stereo effect based on the horizontal positioning characteristic.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer-readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment, in accordance with some implementations.

FIG. 2 illustrates an example pipeline for computing a disparity map (from a stereo image pair during playback to implement real time disparity management, in accordance with some implementations.

FIG. 3 illustrates an environment including a user viewing 3D content rendered behind a portal, in accordance with some implementations.

FIGS. 4A-4E illustrate environments representing differing types of disparity and associated disparity correction techniques, in accordance with some implementations.

FIG. 5 is a flowchart representation of an exemplary method that provides a disparity shift of left eye and right eye image content to control a stereo effect for viewing, in accordance with some implementations.

FIG. 6 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

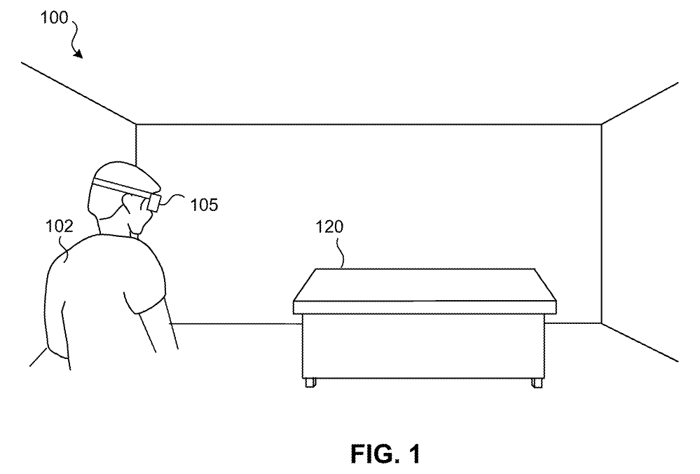

FIG. 1 illustrates an exemplary electronic device 105 operating in a physical environment 100. In the example of FIG. 1, the physical environment 100 is a room that includes a desk 120. The electronic device 105 may include one or more cameras, microphones, depth sensors, or other sensors that can be used to capture information about and evaluate the physical environment 100 and the objects within it, as well as information about the user 102 of electronic device 105. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic device 105 (e.g., a wearable device such as an HMD). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, electronic device 105 may be configured to display a stereo view of image content at a virtual screen position within a 3D environment. The stereo view may be adjusted by shifting a horizontal position of left eye and/or right eye image content within a 3D (e.g., XR) viewing environment to control a stereo effect applied to the image content for user viewing.

In some implementations, image data depicting a scene may be obtained from, inter alia, an image sensor such as a camera, a data storage system, etc. The image data may include one image or multiple images (e.g., frames of a video) to be presented with a stereo effect at a virtual screen position within a 3D viewing environment. For example, the image data may include a photo, a video, etc.

In some implementations, depth data (e.g., generated based on analysis of image data, camera focus distance, IPD parameters, etc.) corresponding to distances of element(s) (e.g., objects) of the scene depicted in the image(s) may be determined or obtained. The distances of the element(s) of the scene may correspond to a reference position such as, inter alia, a capture device or camera position, etc. In some implementations, the distances may account for user or viewer position relative to a virtual screen or image presented via a wearable device such as an HMD.

In some implementations, a horizontal positioning characteristic such as a shift or disparity characteristic may be determined for presenting the images at a virtual screen with a stereo effect applied based on the depth data. The horizontal positioning characteristic may correspond to, inter alia, a size and/or position of image content/virtual screen relative to a viewer of the content, where a viewer of the content is currently looking, etc.)

In some implementations, a view of the images may be presented at the virtual screen within the 3D environment such that the images are presented with the stereo effect based on the horizontal positioning characteristic. For example, presenting the view of the images with the stereo effect may include shifting one or more of the left or right eye images of a stereo image pair in a horizontal direction to control an amount of pop or recess (with respect to a 3D position) of objects in the image(s).

In some implementations, an amount of horizontal shifting may be determined based on image content (of the images) located at minimum and maximum depths of the depth data.

In some implementations, a range of depths of the depth data may be determined to exceed a threshold and accordingly, an amount of a horizontal shift may be determined based on prioritizing specified portions of the image data. The specified portions of the image data may be prioritized based on a saliency map defining visual attributes associated with a view of a user.

In some implementations, the images may additionally be presented with a blur effect, a lighting effect, a vignetting effect, and/or a fading effect to, inter alia, to address UI overlap, a window violation, left/right eye view inconsistencies, etc.

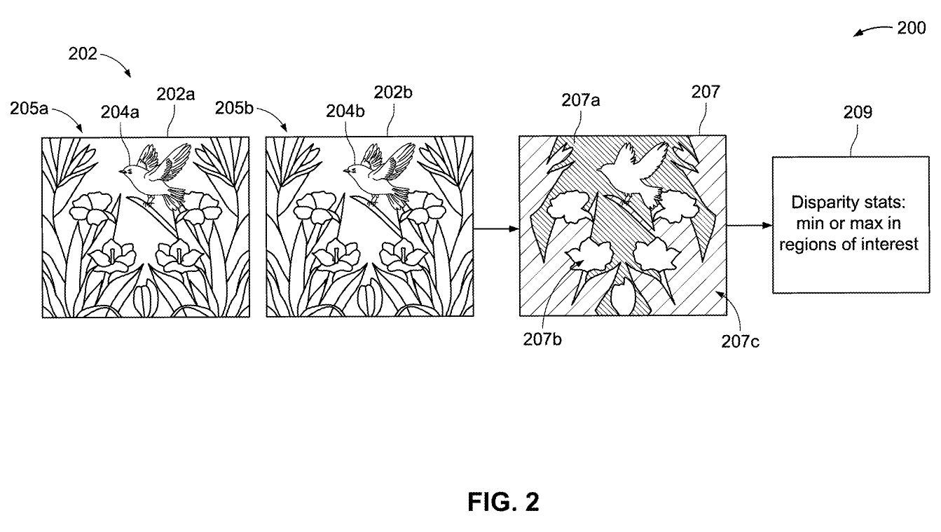

FIG. 2 illustrates an example pipeline 200 for computing a disparity map 207 (e.g., depth) from a stereo image pair 202 (i.e., left eye image 202a and right eye image 202b) of image content (e.g., spatial photos or video content) during playback (for a user) to implement real time disparity management, in accordance with some implementations. Left eye image 202a (e.g., a frame of a video) comprises a left eye view of background content 205a (e.g., background content such as plants, flowers, and grass) and foreground content 204a (e.g., a bird). Likewise, right eye image 202b (e.g., a frame of a video) comprises a right eye view of background content 205b (e.g., background content such as plants, flowers, and grass) and foreground content 204b (e.g., a bird).

In some implementations, stereo image pair 202 is generated by obtaining a left eye view (i.e., left eye image 202a) associated with a left eye viewpoint and a right eye view (i.e., right eye image 202b) associated with a right eye viewpoint of a user (e.g., user 102 of FIG. 1) with respect to a device (e.g., device 110 or 105 of FIG. 1) displaying the left eye image 202a and right eye image 202b. Therefore, when viewed via for example an HMD, the combination of left eye image 202a and right eye image 202b form stereo output image pair 202 depicting a 3D video/representation of content (e.g., background content such as plants, flowers, and grass and foreground content such as a bird) of stereo image pair 202 for viewing on a stereoscopic display of a device such an HMD.

In some implementations, left eye image 202a and right eye image 202b are analyzed (e.g., via image analysis) to compute disparity (depth) map 207 representing an amount of disparity for adjustment to provide adequate user comfort. Disparity map 207 may comprise a depth image (e.g., a low resolution 3-dimensional (3D) model) that includes depth values at original pixel positions that are mapped to a subset of pixel positions of stereo image pair 202.

In some implementations, region 207a represents regions of disparity map 207 associated with a first depth region (e.g., background regions such as grass). In some implementations, region 207b represents regions of disparity map 207 associated with a second depth region (e.g., mid regions with intermediate depth such as plants). In some implementations, region 207c represents regions of disparity map 207 associated with third depth region (e.g., foreground regions such as flowers and a bird).

In some implementations, depth may be computed based on information from a camara during image capture. For example, information from a camera may include a camera focus distance, interpupillary distance (IPD) parameters, etc.

In some implementations, minimum and maximum depths 209 (with respect to a region of interest) for all frames of a video (image content) may be used (e.g., creating a depth range for the video as a whole) to determine a horizontal shift that will be used for all frames. Likewise, scene data may be used to determine a horizontal shift. For example, indoor vs. outdoor scene data, camera focus, camera depth of field, etc. to determine a horizontal shift.

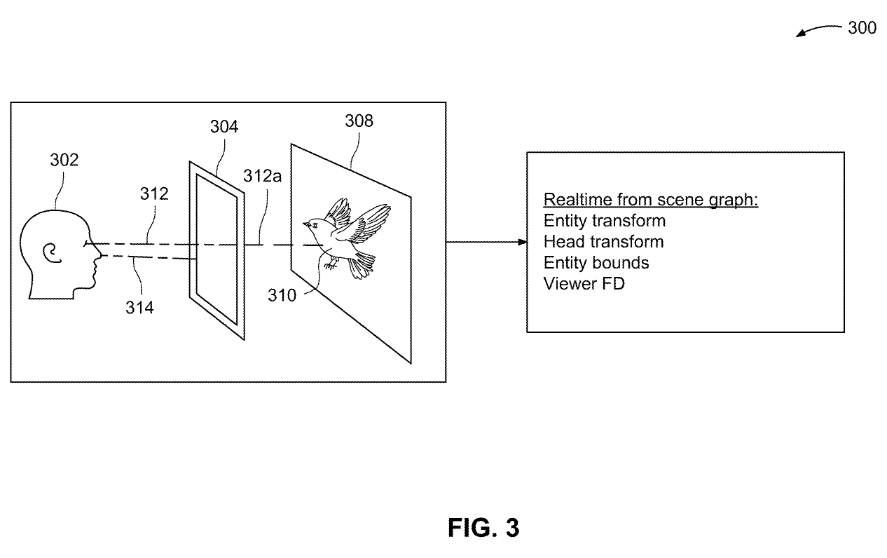

FIG. 3 illustrates an environment 300 including a user viewpoint position 302 for a view to be provided to a user (e.g., via an HMD). The view from the user viewpoint position 302 will include 3D content 308 rendered behind a portal 304 within the 3D environment 300. FIG. 3 illustrates positional relationships (e.g., between user viewpoint position 302, 3D content 308, and portal 304) that may be used in determining how to display the user’s view of the 3D environment 300 (e.g., in an HMD) such that the 3D content 308 is displayed within that view in a way that provides a comfortable or otherwise desirable user experience.

In some implementations, a size of the 3D content 308 (e.g., a portion of the 3D content 308 such as object (e.g., a rendering of a bird) 310) being rendered in the user’s view (e.g., on the HMD) may be determined. In some implementations, 3D content 308 being rendered behind portal 304 in the user’s view (e.g., on the HMD) may enable the system to determine a size of 3D content 308. In some implementations, a size of the portal 304 and an associated distance 312a of 3D content 308 with respect to portal 304 may likewise be determined. In some implementations, a distance between the user’s eyes (e.g., an IPD) may be determined. Likewise, a distance 314 between the user viewpoint position 302 and the portal 304 and a distance 312 between the user viewpoint position 302 and the 3D content 308 and/or object 310 may be determined. The aforementioned sizes (e.g., of 3D content 308, portal 304, etc.) and distances (e.g., distance 312, distance 312a, distance 314, IPD, etc.) may continuously change during content viewing as portal 304 may be moved or resized within the environment 300 based on different viewing conditions. For example, differing viewing conditions may be caused by, inter alia, head movement of the user, which may change the user viewpoint position 302 within the 3D environment or may cause differing applications associated with different setup attributes and different hardware platforms to affect playback conditions, which may require disparity adjustments to 3D content 308.

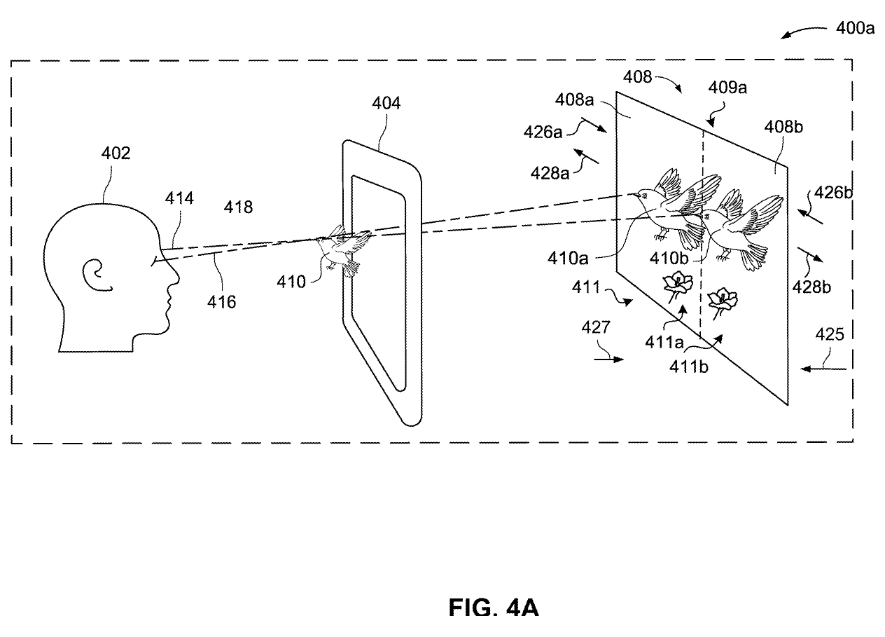

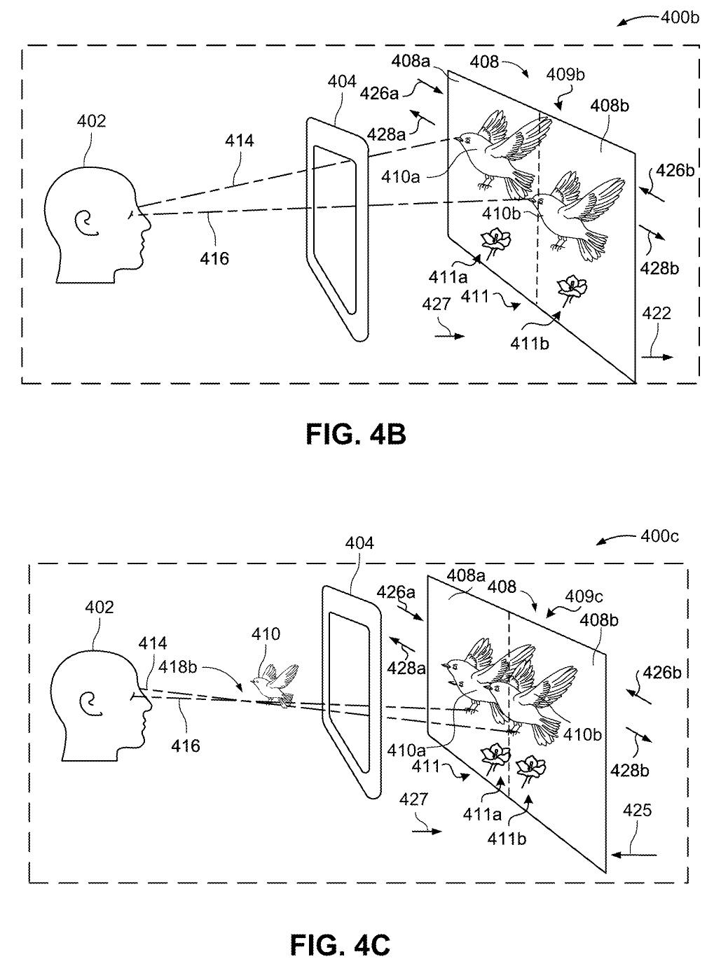

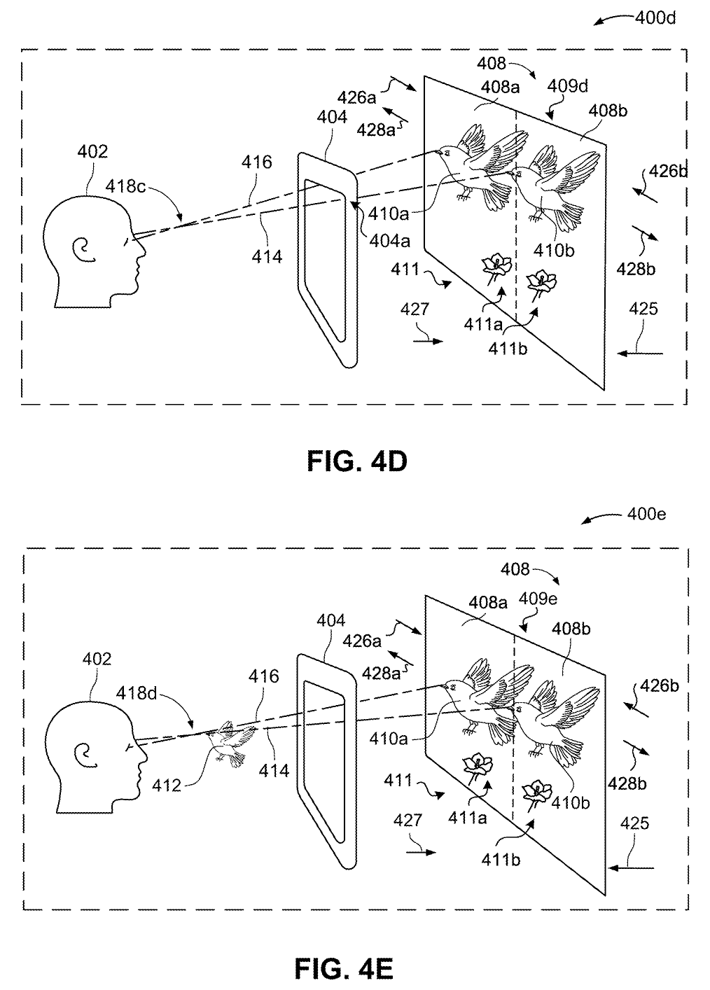

FIGS. 4A-4E illustrate 3D environments 400a-400e representing differing types of disparity and associated disparity correction techniques, in accordance with some implementations. FIGS. 4A-4E illustrate 3D environments 400a-400e including a user viewpoint position 402 for a view to be provided to a user (e.g., via an HMD). The view from the user viewpoint position 402 will include 3D image content (e.g., a 3D object such as a bird 410) rendered behind a portal 404 within the 3D environment 400. Likewise, FIGS. 4A-4E illustrate positional relationships (e.g., between user viewpoint position 402, 3D content 408, and portal 404) that may be used in determining how to display the user’s view of the 3D environments 400a-400e (e.g., in an HMD) such that the 3D content 408 is displayed within that view in a way that provides a comfortable or otherwise desirable user experience.

FIG. 4A illustrates 3D image content 408 being generated by presenting a stereo image pair 409a (i.e., left eye image 408a and right eye image 408b) representing image content (e.g., spatial photos or video content) during playback for user 402. Left eye image 408a (e.g., a frame of a video) includes a left eye view of background content 411a (e.g., background content such as flowers) and foreground content 410a (e.g., a bird). Likewise, right eye image 408b (e.g., a frame of a video) includes a right eye view of background content 411b (e.g., background content such as flowers) and foreground content 410b (e.g., a bird).

In some implementations, stereo image pair 409a may be generated by generating a left eye view (i.e., left eye image 408a) associated with a left eye viewpoint and a right eye view (i.e., right eye image 408b) associated with a right eye viewpoint of a user’s view 402 (on an HMD) with respect to a device (e.g., device 105 of FIG. 1) displaying the left eye image 408a and right eye image 408b via portal 404. Therefore, when viewed via, for example an HMD, the combination of left eye image 408a and right eye image 408b form stereo output image pair 409a depicting a 3D video/representation of content (e.g., background content 411 such as flowers and foreground content such as bird 410) of stereo image pair 409a for viewing on a stereoscopic display of a device such an HMD.

In some implementations, left eye image 408a and right eye image 408b provide a stereo effect (e.g., via a view on an HMD) by controlling an amount that objects in stereo image pair 409a appear to pop (e.g., bird 410) or appear recessed (e.g., background content 411 of stereo image pair 409a). In some implementations, an amount that objects in stereo image pair 409a appear to pop (e.g., bird 410) or appear recessed may be controlled by adjusting a horizontal shift or movement (e.g., in horizontal directions 426a and 426b or 428a and 428b) with respect to left eye image 408a and right eye image 408b. In some implementations, an observed disparity may depend on the horizontal shift and a depth (e.g., with respect to directions 425 and 427) of objects in the view. In some implementations, disparity may affect user comfort such that object may appear to be more rounded or elongated depending on how far away an object is with respect to a view and a nature or amount of the horizontal shift. Disparity may additionally affect stereo comfort and a sense of scale.

In some implementations, the amount of horizontal shift used to correct disparity issues may be based on a type of content (e.g., a bird in a background scene) that the user 402 is viewing. In some implementations, a view of the content may change for a video file or stream based on a size of the portal 404 or a distance between the user’s eyes and the portal. For example, with respect to disparity for a single pixel (e.g., a beak of the bird 410), a calculation associated with a gaze direction (of eyes of the user) may be used to extend the user gaze (associated with both eyes) via rays 414 and 416 of light such that the object (i.e., bird 410) may be perceived in 3D at a location 418 of an intersection between rays 414 and 416.

FIG. 4B illustrates a 3D environment 400b. In contrast with 3D environment 400a of FIG. 4A, environment 400b represents left eye image 408a and right eye image 408b (of stereo image pair 409b) horizontally shifted in directions 428a and 428b such that background content 411a and foreground content 410a are located further distances from each other. Accordingly, rays 414 and 416 do not intersect due to gaze directions of the eyes of the user being further from each other thereby preventing an object (e.g., a bird 410) from being rendered in 3D. Likewise, this may cause a visual disparity that includes double vision (e.g., with respect to foreground content 410a and 410b (e.g., a bird) and background content 411a and 411b (e.g., flowers)) caused by too much horizontal distance between left eye image 408a and right eye image 408b. In some implementations, a horizontal shift may be applied to move left eye image 408a and right eye image 408b in directions 426a and 426b bringing them closer together such that rays 414 and 416 begin to intersect thereby resolving the disparity and enabling a 3D view of an object such as, for example, bird 310 of FIG. 4A.

FIG. 4C illustrates a 3D environment 400c. In contrast with 3D environment 400b of FIG. 4B, 3D environment 400c of FIG. 4C represents left eye image 408a and right eye image 408b (of stereo image pair 409c) horizontally shifted in directions 426a and 426b such that foreground content 410a and 410b and background content 411a and 411b are located in positions that are closer to each other thereby causing rays 414 and 416 to intersect at a location 418b. Accordingly, an object 410 (e.g., a bird) is presented in 3D such that the portal 404 is perceived at a location behind the object 410 but in front of a location of stereo image pair 409c thereby causing a depth disparity that may be uncomfortable for the user. In some implementations, a horizontal shift may be applied to move left eye image 408a and right eye image 408b in directions 428a and 428b bringing them further apart (horizontally) resulting in object 410 being moved in a direction 427 to a location within or behind portal 404 thereby resolving the disparity and enabling a comfortable 3D view of object 410.

FIG. 4D illustrates a 3D environment 400d. In contrast with 3D environment 400b of FIG. 4B, 3D environment 400d of FIG. 4D represents a window violation issue causing a point of interest (e.g., the bird of foreground content 410a and 410b) to be visible in one eye but not the other eye of the user. For example, a left eye of the user (associated with ray 414) may be able to view the bird but the right eye of the user (associated with ray 416) may be unable view the bird because a side portion 404a of portal 404 is obstructing a view of the right eye the user. In some implementations, this disparity may be resolved by applying a feathering effect to an inside edge of portion 404a to dynamically adjust a width of the portal 404 and enable a view of the bird.

FIG. 4E illustrates a 3D environment 400e. In contrast with 3D environment 400c of FIG. 4C, 3D environment 400e of FIG. 4E represents excessive negative disparity associated with rendering object 410 at a position that is too close to the eyes of the user thereby causing the user to cross their eyes to see the object 410. In this instance, a horizontal shift may be applied to move left eye image 408a and right eye image 408b in directions 428a and 428b or 426a and 426b causing the object 410 to be moved in a direction 427 to a location within or behind portal 404 thereby resolving the disparity and enabling a comfortable 3D view of object 410.

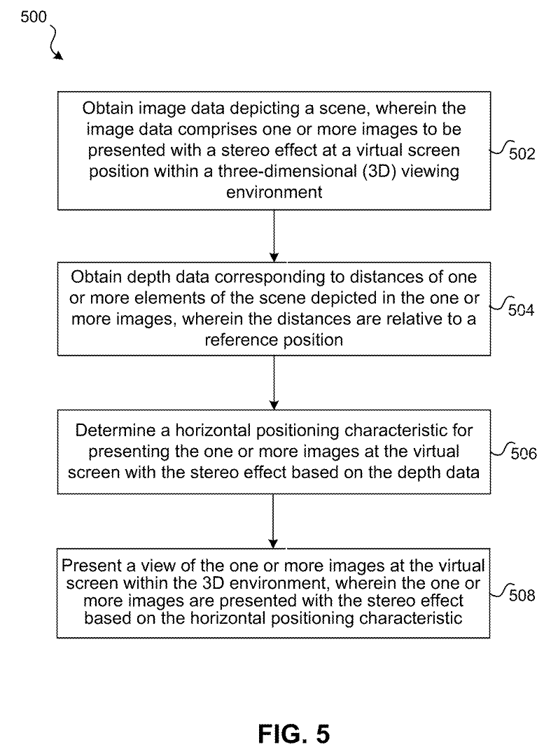

FIG. 5 is a flowchart representation of an exemplary method 500 that provides a disparity shift of left eye and right eye image content to control a stereo effect for viewing, in accordance with some implementations. In some implementations, the method 500 is performed by a device, such as a mobile device, desktop, laptop, HMD, or server device (e.g., device 110 of FIG. 1). In some implementations, the device has a screen for displaying images and/or a screen for viewing stereoscopic images such as a head-mounted display (HMD such as e.g., device 105 of FIG. 1). In some implementations, the method 500 is performed by processing logic, including hardware, firmware, software, or a combination thereof. In some implementations, the method 500 is performed by a processor executing code stored in a non-transitory computer-readable medium (e.g., a memory). Each of the blocks in the method 500 may be enabled and executed in any order.

In some implementations, method 500 provides a user viewpoint position for a view to be provided to a user (e.g., via an HMD). The view from the user viewpoint position may include 3D content rendered behind a portal within a 3D environment. In some implementations, positional relationships (e.g., between a user viewpoint position, 3D content, and a portal) may be used to determine how to display the user’s view of the 3D environment (e.g., in an HMD) such that the 3D content is displayed within that view in a way that provides a comfortable or otherwise desirable user experience.

At block 502, the method 500 obtains image data depicting a scene. In some implementations, the image data (e.g., a photo, a video, etc.) includes images to be presented with a stereo effect (stereo image pair 409a as described with respect to FIG. 4A) at a virtual screen (e.g., portal 404 as described with respect to FIG. 4A) position within a three-dimensional (3D) viewing environment.

At block 504, the method 500 obtains depth data corresponding to distances of one or more elements of the scene depicted in the images (e.g., disparity map 207 as described with respect to FIG. 2). In some implementations the distances may be relative to a reference position such as a capture device/camera position as described with respect to FIG. 1. In some implementations, the distances may account for an HMD user/viewer position/viewpoint relative to a virtual screen/image.

In some implementations, the depth data may be determined based on analysis of the image data.

In some implementations, the depth data may be determined based on data from an image sensor used to capture the image data. For example, camera focus distance, IPD parameters, etc.

At block 506, the method 500 determines a horizontal positioning characteristic for presenting the images at the virtual screen with the stereo effect based on the depth data as described with respect to FIG. 2.

In some implementations, the horizontal positioning characteristic may correspond to an amount of horizontal shift applied to at least one of the images.

In some implementations, the amount of horizontal shift may be determined based on characteristics of a playback environment associated with presenting the view. For example, a size and/or position of the image content/virtual screen relative to the viewer, where the viewer is looking, etc. as described with respect to FIG. 3.

In some implementations, the amount of horizontal shift may be determined based on image content of at least one of the images located at minimum and maximum depths of the depth data. For example, minimum and maximum depths 209 of disparity map 207 as described with respect to FIG. 2.

In some implementations, the amount of horizontal shift may be determined based on image content of all of the images located at minimum and maximum depths of the depth data.

In some implementations, a range of depths of the depth data may exceed a threshold and the amount of a horizontal shift may be determined based on prioritizing specified portions of the image data.

In some implementations, the specified portions of the image data may be prioritized based on a saliency map that defines visual attributes associated with a view of a user.

At block 508, the method 500 presents a view of the images at the virtual screen within the 3D environment such that the images are presented with the stereo effect based on the horizontal positioning characteristic as described with respect to FIGS. 4A-4E.

In some implementations, the images may be presented with a blur effect. to address UI overlap, window violation, and left/right eye view inconsistencies, etc.

In some implementations, the images may be presented with a lighting effect, for example, to address user interface UI overlap, window violations, left/right eye view inconsistencies, etc.

In some implementations, the images may be presented with a vignetting effect to address UI overlap, window violation, and left/right eye view inconsistencies, etc. For example, a brightness or saturation treatment at the edges or the periphery of the images may be reduced as compared to a center portion of the video frame.

In some implementations, the images may be presented with a fading effect (e.g., at a periphery of the images) to address UI overlap, window violation, and left/right eye view inconsistencies.

In some implementations, the images may be presented with any combination of a blur effect, a lighting effect, a vignetting effect, and/or a fading effect to address UI overlap, window violation, and left/right eye view inconsistencies.

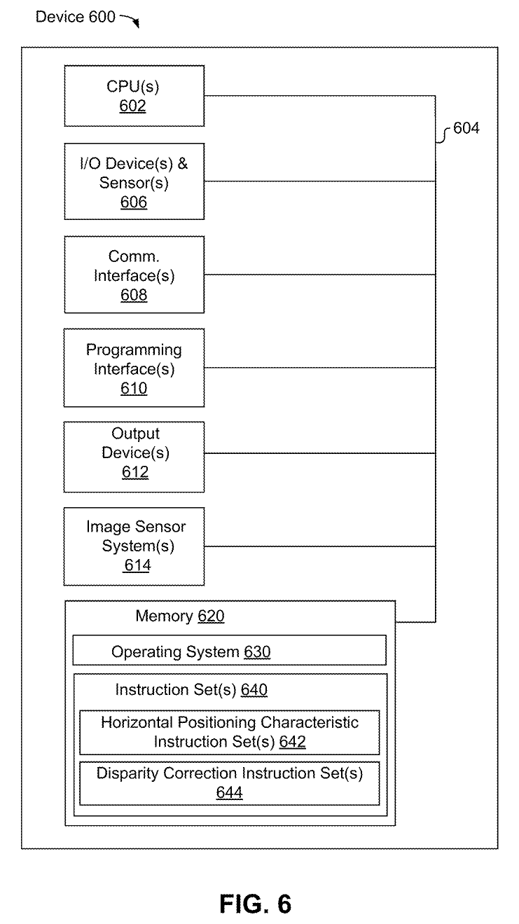

FIG. 6 is a block diagram of an example device 600. Device 600 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 600 includes one or more processing units 602 (e.g., microprocessors, ASICs, FPGAs, GPUs, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 610, output devices (e.g., one or more displays) 612, one or more interior and/or exterior facing image sensor systems 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more output device(s) 612 include one or more displays configured to present a view of a 3D environment to the user. In some implementations, the one or more displays are configured to present a view of a physical environment, a graphical environment, an extended reality environment, etc. to the user. In some implementations, the one or more displays are configured to present content (determined based on a determined user/object location of the user within the physical environment) to the user. In some implementations, the one or more displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 600 includes a single display. In another example, the device 600 includes a display for each eye of the user.

In some implementations, the one or more output device(s) 612 include one or more audio producing devices. In some implementations, the one or more output device(s) 612 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener’s brain into interpreting sounds as if the sounds occurred at the point(s) in the 3D environment (e.g., from one or more particular sound sources) even though the actual sounds may be produced by speakers in other locations. The one or more output device(s) 612 may additionally or alternatively be configured to generate haptics.

In some implementations, the one or more image sensor systems 614 are configured to obtain image data that corresponds to at least a portion of the physical environment 100. For example, the one or more image sensor systems 614 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 614 further include illumination sources that emit light, such as a flash. In various implementations, the one or more image sensor systems 614 further include an on-camera image signal processor (ISP) configured to execute a plurality of processing operations on the image data.

In some implementations, the device 600 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 600 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 600.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 includes a non-transitory computer readable storage medium.

In some implementations, the memory 620 or the non-transitory computer readable storage medium of the memory 620 stores an optional operating system 630 and one or more instruction set(s) 640. The operating system 630 includes procedures for handling various basic system services and for performing hardware dependent tasks. In some implementations, the instruction set(s) 640 include executable software defined by binary information stored in the form of electrical charge. In some implementations, the instruction set(s) 640 are software that is executable by the one or more processing units 602 to carry out one or more of the techniques described herein.

The instruction set(s) 640 includes a horizontal positioning instruction set 642 and a disparity correction presentation instruction set 644. The instruction set(s) 640 may be embodied as a single software executable or multiple software executables.

The horizontal positioning instruction set 642 is configured with instructions executable by a processor to determine a horizontal positioning characteristic such as a shift for presenting images with resolved disparity.

The disparity correction presentation instruction set 644 is configured with instructions executable by a processor to present a view of the images with a stereo effect based on the horizontal positioning characteristic.

Although the instruction set(s) 640 are shown as residing on a single device, it should be understood that in other implementations, any combination of the elements may be located in separate computing devices. Moreover, FIG. 6 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a head mounted device (HMD) having a processor:
obtaining image data depicting a scene, wherein the image data comprises one or more images to be presented with a stereo effect at a virtual screen position within a three-dimensional (3D) viewing environment;
obtaining depth data corresponding to distances of one or more elements of the scene depicted in the one or more images, wherein the distances are relative to a reference position;
determining a horizontal positioning characteristic for presenting the one or more images at the virtual screen with the stereo effect based on the depth data; and
presenting a view of the one or more images at the virtual screen within the 3D environment, wherein the one or more images are presented with the stereo effect based on the horizontal positioning characteristic.

2. The method of claim 1, wherein the depth data is determined based on analysis of the image data.

3. The method of claim 1, wherein the depth data is determined based on data from an image sensor used to capture the image data.

4. The method of claim 1, wherein the horizontal positioning characteristic corresponds to an amount of horizontal shift applied to at least one of the one or more images.

5. The method of claim 4, wherein the amount of horizontal shift is determined based on characteristics of a playback environment associated with said presenting the view.

6. The method of claim 4, wherein the amount of horizontal shift is determined based on image content of at least one of the one or more images located at minimum and maximum depths of the depth data.

7. The method of claim 4, wherein the amount of horizontal shift is determined based on image content of all of the one or more images located at minimum and maximum depths of the depth data.

8. The method of claim 4, wherein a range of depths of the depth data exceeds a threshold, and wherein the amount of a horizontal shift is determined based on prioritizing specified portions of the image data.

9. The method of claim 8, wherein the specified portions of the image data are prioritized based on a saliency map defining visual attributes associated with a view of a user.

10. The method of claim 1, wherein the one or more images are presented with a blur effect.

11. The method of claim 1, wherein the one or more images are presented with a lighting effect.

12. The method of claim 1, wherein the one or more images are presented with a vignetting effect.

13. The method of claim 1, wherein the one or more images are presented with a fading effect.

14. A head mounted device (HMD) comprising:
a non-transitory computer-readable storage medium; and
one or more processors coupled to the non-transitory computer-readable storage medium, wherein the non-transitory computer-readable storage medium comprises program instructions that, when executed on the one or more processors, cause the HMD to perform operations comprising:
obtaining image data depicting a scene, wherein the image data comprises one or more images to be presented with a stereo effect at a virtual screen position within a three-dimensional (3D) viewing environment;
obtaining depth data corresponding to distances of one or more elements of the scene depicted in the one or more images, wherein the distances are relative to a reference position;
determining a horizontal positioning characteristic for presenting the one or more images at the virtual screen with the stereo effect based on the depth data; and
presenting a view of the one or more images at the virtual screen within the 3D environment, wherein the one or more images are presented with the stereo effect based on the horizontal positioning characteristic.

15. The HMD of claim 14, wherein the depth data is determined based on analysis of the image data.

16. The HMD of claim 14, wherein the depth data is determined based on data from an image sensor used to capture the image data.

17. The HMD of claim 14, wherein the horizontal positioning characteristic corresponds to an amount of horizontal shift applied to at least one of the one or more images.

18. The HMD of claim 17, wherein the amount of horizontal shift is determined based on characteristics of a playback environment associated with said presenting the view.

19. The HMD of claim 17, wherein the amount of horizontal shift is determined based on image content of at least one of the one or more images located at minimum and maximum depths of the depth data.

20. A non-transitory computer-readable storage medium storing program instructions executable via one or more processors, of a head mounted device (HMD), to perform operations comprising:
obtaining image data depicting a scene, wherein the image data comprises one or more images to be presented with a stereo effect at a virtual screen position within a three-dimensional (3D) viewing environment;
obtaining depth data corresponding to distances of one or more elements of the scene depicted in the one or more images, wherein the distances are relative to a reference position;
determining a horizontal positioning characteristic for presenting the one or more images at the virtual screen with the stereo effect based on the depth data; and
presenting a view of the one or more images at the virtual screen within the 3D environment, wherein the one or more images are presented with the stereo effect based on the horizontal positioning characteristic.
